(19) United States
(12) Patent Application Publication
(10) Pub. No.: US 2007/0210579 A1
(43) Pub. Date: Sep. 13, 2007

(54) SYSTEMS AND METHODS FOR REINFORCING JOINED SEGMENTS OF DUCT WORK

(75) Inventor: Steve Thornton, South Mills, NC (US)

Correspondence Address: TROUTMAN SANDERS LLP, 600 PEACHTREE STREET , NE, ATLANTA, GA, 30308, US

(73) Assignee: Lindab, Inc., Portsmouth, VA (US)

(21) Appl. No.: 11/684,483

(22) Filed: Mar. 9, 2007

Related U.S. Application Data
(60) Provisional application No. 60/780,751, filed on Mar. 9, 2006.

(51) Int. Cl. F16L 25/00

(52) U.S. Cl. 285/424

(57) ABSTRACT

Systems and methods for reinforcing joined segments of duct work for enabling a secured seal between two duct segments is provided. The device comprises a non-circular duct segment having a joining element on the non-circular duct segment and a reinforcement region located proximate to the joining element.

### CROSS REFERENCE TO RELATED APPLICATIONS

This application claims priority of U.S. Provisional Patent Application No. 60/780,751, filed 9 Mar. 2006, the entire contents and substance of which are hereby incorporated by reference.

### FIELD OF THE INVENTION

The present invention relates generally to the field of ventilation duct systems and specifically to an apparatus and method for reinforcing joined segments of duct work.

### BACKGROUND

Ventilation systems are used in almost every type of building or structure to deliver and maintain proper temperature levels, atmospheric content, and filter impurities from the air. Ventilation systems or Heating Ventilating and Air-Conditioning (HVAC) systems typically utilize duct work systems as the backbone of the air filtration and ventilation network. These duct work systems provide an efficient means by which to ventilate structures, such as office buildings, commercial facilities, and residences. Various configurations of the shape, size, and connections of the integral portions of the duct systems provide for optimal, efficient, and durable ventilation systems.

There are different types of ducts, including, but not limited to, circular ducts, rectangular ducts, and oval ducts. The circular ducts have a circular cross section in which the air flows. Similarly, the rectangular ducts have a rectangular cross section and the oval ducts have an oval cross section. Each type of duct may have differing properties and, thus, may be more suitable for certain implementations than others. Oval ducts have become increasingly popular in ventilation systems because they provide superior properties to both rectangular and circular duct in a significant portion of implementations.

Duct work systems are typically installed by joining and laying a number of different prefabricated sections. In order to create a dependable, reliable, and efficient ventilation system, the prefabricated sections must be capable of maintaining their integrity throughout the delivery and installation process, including packaging, transportation to the job site, joining to other prefabricated sections, and installation. Often times, the installer must handle and manipulate the prefabricated sections to join them together and install them into what are typically compact locations. This installation process may sometimes lead to the application of potentially deforming forces to the prefabricated sections. Therefore, the prefabricated sections must be capable of withstanding these potentially deforming forces to ensure their integrity is maintained throughout the installation and service.

The prefabricated sections come in various shapes and configurations to provide for the specific needs of a section of the duct work system. Prefabricated sections may be straight sections of duct work or fittings such as elbows, tees, branches, transitions, reducers, end caps and other pieces where applicable. The fittings are connected with other pieces to accommodate for turns in the duct work system, junctions, termination, and other applications.

Joint assemblies are well known for the connection of the duct segments that make up a prefabricated section. Conventionally, a joining element is used to join duct segments to create a particular fitting such as elbows, tees, and branches.

While suitable for their intended purposes, the conventional methods of joining duct segments to create prefabricated duct sections present problems with respect to durability, reliability, and vulnerability. For many joint assembly techniques, the resulting prefabricated section is vulnerable because movement, shifting, or application of a force to the duct structures may lead to a separation in the joint between two duct segments. More particularly, the joint between two segments of oval duct is especially vulnerable to separation if pressure is applied to an area in the flat section of the oval. Pressure on the oval duct may lead to separation of the joint and, thus, a breach in the integrity of prefabricated duct section.

### BRIEF SUMMARY

The various embodiments of present invention over the problems in the art and provide improved apparatuses, systems, and methods enabling users to securely join segments of duct work.

In some embodiments of the present invention, the device comprises a non-circular duct segment having a joining element on the non-circular duct segment and a reinforcement region located proximate to the joining element.

In addition, the various embodiments of the present invention enable users to effectively and efficiently reinforce the sealed joints between duct segments without incurring the above discussed drawbacks.

### BRIEF DESCRIPTION OF THE DRAWINGS

FIG. 1 is an illustration of the apparatus for reinforcing joined segments of duct work in accordance with some embodiments of the present invention;

FIG. 2 is an illustration of the apparatus for reinforcing joined segments of duct work in accordance with some embodiments of the present invention from a side perspective.

FIG. 3 is a cross-sectional view of an alternate embodiment of non-circular duct apparatus in accordance with the present invention.

### DETAILED DESCRIPTION

Referring now in detail to the figures, wherein like reference numerals represent like parts throughout the several views.

Ventilation system installation and system performance are greatly improved when the joints connecting the duct segments of the prefabricated duct sections are durable and reliable. Often times the duct work of a ventilation system may be an intricate network of duct sections with a significant number of fittings to accommodate for the layout of the system throughout a building. The joined duct segments of the prefabricated duct sections must remain intact for assembly and mounting, not to mention service after installation.

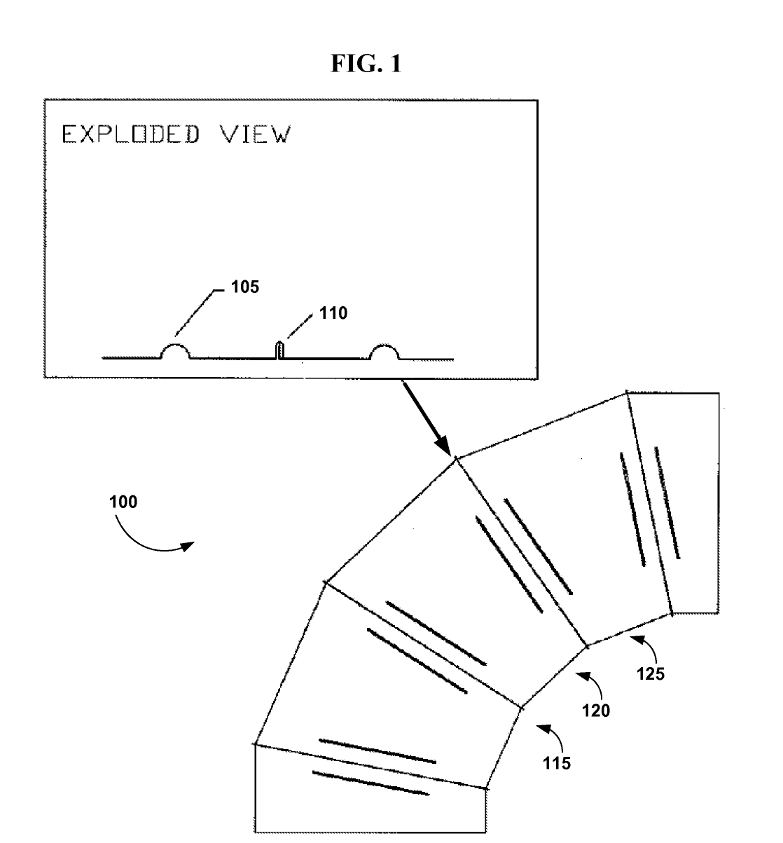

FIG. 1 is a top view of a portion of a non-circular duct apparatus 100 of an overall duct network incorporating an exemplary embodiment of the present invention. FIG. 1 shows a portion of an overall duct system, more particularly the non-circular duct apparatus 100 shown in FIG. 1 is an elbow section. In an exemplary embodiment, the non-circular duct apparatus 100 depicted in FIG. 1 may be made up of many non-circular duct segments. Those of skill in the art will appreciate that duct systems, may be made up of a variety of different straight conduit and connection devices, such as elbows, tees, branches, transitions, reducers, end caps and other pieces where applicable. Those of skill in the art will appreciate that the non-circular duct apparatus 100 could be any of these types of systems or portions of duct systems.

In an exemplary embodiment, the non-circular duct apparatus 100 depicted in FIG. 1 may be made up of non-circular duct segments 115, 120, and 125. In assembling the non-circular duct apparatus 100, these individual non-circular duct segments may be joined together to create a sealed conduit for the flow of air. In an exemplary embodiment, the non-circular duct segments 115, 120, and 125 of the non-circular duct apparatus 100 may be joined in an off-site manufacturing plant, transported to the job site, and installed with the remainder of the duct system. In an alternative embodiment, the non-circular duct segments 115, 120, and 125 may be joined at the location of use.

A joining element 110 may be provided at a connecting end of a duct segment. In an exemplary embodiment of the present invention, this joining element 110 may be a standing seam as depicted in the exploded view portion of FIG. 1. The joining element 110 creates a physically mated connection between duct segments, such as duct segments 120 and 125 shown in the exemplary embodiment in FIG. 1. In an exemplary embodiment of the present invention, the standing seam joint surface of duct segment 125 provides an upwardly protruding member. Similarly, the standing seam joint surface of duct segment 120 provides the mating member of the standing seam joining element 110, consisting of parallel supports which wrap around the protruding member. Once the upwardly protruding member may be inserted in between the parallel connecting supports, the joining elements may be fully mated and bound.

While the joining element 110 provides a physical connection for the joint between two duct segments, such as duct segments 120 and 125, this joint may be vulnerable to separation. A force applied to the joint may potentially cause the upwardly protruding member of the joining element 110 to separate from the parallel connecting supports of the joining element 110; thus, separating the joint or, alternatively, degrading the integrity of the joint. Oval ducts may be especially vulnerable to such separation forces, because the flat surface of the oval structure may be easily deformed when a force may be applied to the flat surface of the relatively thin sheet metal or other material from which the duct segment was fabricated.

To improve the durability and rigidity of the joints of the non-circular duct apparatus 100, an exemplary embodiment of the present invention provides a reinforcement region 105 proximate to the joining element 110. The reinforcement region 105 enables the area proximate to the joint in the duct segment 120 to resist potentially deforming forces, which may be applied to the duct segment.

In an exemplary embodiment of the present invention, the reinforcement region 105 may be made up of a bead, which may be formed on the flat span of the non-circular duct segment 120 in an area proximate to the joining element 110. A bead may be formed in sheet metal by drawing the metal through a bead forming tool, such as a bead roller, a power drive bead roller, or other rotary machine. The bead may be formed and shaped in accordance with the particular bead die used, such as a ⅜″ bead die, a ½″ bead die, a ½″ step die, or a ¼″ inch step die. Those of skill in the art will appreciate that many types of bead die and bead forming tool may be used to shape the sheet metal without detracting from the scope of the invention. When the sheet metal may be drawn through the bead forming tool, it may be thinned and stretched to conform to the shape of the bead die, and the resulting bead creates a reinforced area in the sheet metal. In an exemplary embodiment, this bead reinforces the non-circular duct segment 120 and reduces the duct segment 120's susceptibility to deforming forces. Reinforcing the duct segment 120, and thereby making it less susceptible to deforming forces, significantly decreases the likelihood that the joining element 110 will separate. In a non limiting example, when a force is applied to the flat portion of duct segment 120, the bead provides resistance to the force so that the duct segment 120 may maintain its rigidity and shape, thus preventing separation of joining element 110.

In an exemplary embodiment of the present invention, the thickness of the bead may preferably be between 0.375 inches to 0.5 inches. The standing seam joining element 110, on the other hand, may be any of a variety of types and size without departing from the scope of the invention. In an exemplary embodiment, the standing seam joining element 110 may be a 0.25 inch seam.

The bead of the reinforcement region 105, in exemplary embodiment, may be placed in close proximity to the joining element 110. In a non-limiting example, the bead may be located one to two inches from the joining element 110 in an exemplary embodiment. Those of skill in the art will appreciate that these dimensions are provided as examples only and may vary depending upon many factors, such as the thickness of the sheet metal structure of the duct segment, the thickness of the standing seam, and other variables.

Preferably, the reinforcement region 105 is close enough to the joining element 110 to inhibit the deformation of the duct segment. In an exemplary embodiment, the reinforcement region 105 is located no more than ⅓ of the distance to the opposite edge of the duct segment (the total longitudinal length of the duct segment). In one embodiment, the reinforcement region 105 is positioned no more than 6 inches from the joining element 110, and more preferably between 1 inch and 3 inches from the joining element 110. Additionally, the reinforcement region 105 can be placed in relation to the size of the opening of the duct segment. In an exemplary embodiment, the reinforcement region 105 is placed a distance from the joining element 110 that is no more than the length of the major axis of the opening of the duct segment. In an alternative embodiment, the reinforcement region 105 is placed a distance from the joining element 110 that is no more than ½ of the length of the major axis of the opening of the duct segment.

The reinforcement region 105 may be created in a variety of ways including, but not limited to, a bead, bend, ogee bead, crimp, banding, metal insert, an extra layer of material or compound, or numerous other reinforcement devices. In an alternative exemplary embodiment of the present invention, the reinforcement region 105 may be comprised of a bend in the wall structure of the duct segment at the reinforcement regions. In a non-limiting example, the duct segment 120 may be made up of thin sheet metal. To create the reinforcement region 105, a bend may be placed in the duct segment 120 in a location proximate to the joining surface of the duct segment 120. This bend may provide additional rigidity to the duct segment 120 in the area of the joining element 110, creating the reinforcement region 105, and thus enabling the duct segment 120 to resist forces which might lead to a separation of the joining element 110. In another alternative exemplary embodiment of the present invention, a metal band may be joined to sheet metal to create the reinforcement region 105 in the proximity of the joining element 110. The metal band provides additional rigidity to decrease the likelihood of separation of the joining element 110.

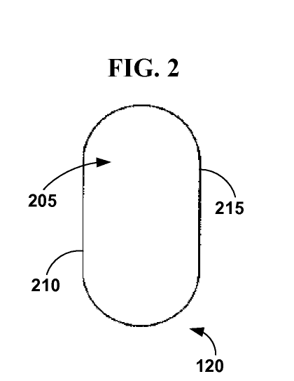

FIG. 2 is an illustration of an oval duct segment 120, in an exemplary embodiment, from a side perspective looking into the internal cavity 205 of the oval duct segment 120. As shown in the figure, the non-circular duct segment 120 has two flat regions, 210 and 215. It is in these flat regions, 210 and 215, that the non-circular duct segment 120 may be most susceptible to deforming forces, which may lead to separation of the joint to another segment.

Reference has been made to the use of a standing seam to join the duct segments, such as joining element 110, but those of skill in the art will appreciate that a variety of joining elements could be implemented without departing from the scope of the invention. Joining elements, such as a “T” connection, a Pittsburgh roll, a double seam roll, or a right-angle flange roll, may be used as an alternative to a standing seam to join two duct segments.

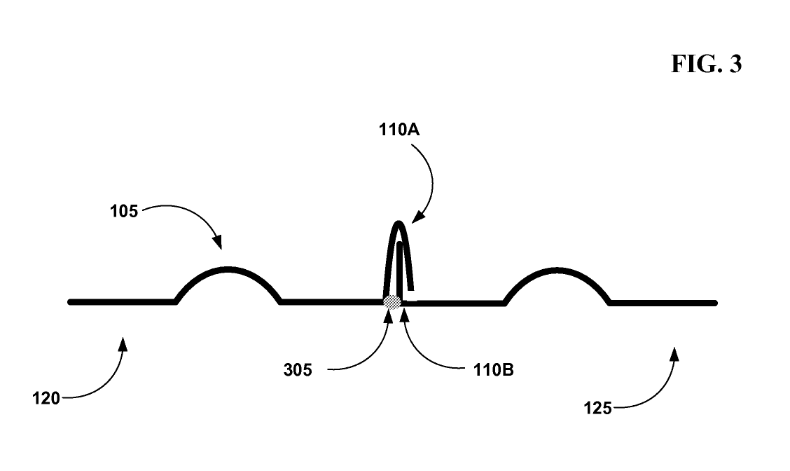

FIG. 3 is a cross-sectional view of an alternate embodiment of non-circular duct apparatus in accordance with the present invention. In this alternative embodiment of the present invention, the joining element 110A of non-circular duct segment 120 and the joining element 110B of non-circular duct segment 125 may be further secured by welding. First joining element 110A of non-circular duct segment 120 may be physically mated to the joining element 110B of non-circular duct segment 125, shown in FIG. 3. Then, the joining elements 110A and 110B may be welded together. In one embodiment, the joining elements 110A and 110B may be welded together with a tack weld 305. As shown in exemplary embodiment in FIG. 3, the tack weld 305 can be positioned inside the non-circular duct segment 120 and the non-circular duct segment 125. More particularly, this tack weld 305 can be used to bond the base of the joining element 110A to the joining element 110B. In an alternative embodiment, not depicted in FIG. 3, the tack weld 305 could be positioned on the outside of non-circular duct segment 120 and non-circular duct segment 125. Those of skill in the art will appreciate that numerous different welding methods could be used without detracting from the scope of the invention.

The tack weld 305 of the joining elements, 110A and 110B, of the non-circular duct segments, 120 and 125, may assist in improving the rigidity and durability of the non-circular duct apparatus 100 made up by the non-circular duct segments, 120 and 125. This tack weld 305 may improve the ability of the resulting non-circular duct apparatus 100 to resist tension forces. Therefore, in addition to the reinforcement region 105, which assists in enabling the non-circular duct apparatus 100 to resist forces that might lead to a separation of the joining elements, the tack weld 305 of the joining elements, 110A and 110B, aids in increasing the durability and rigidity of the overall non-circular duct apparatus 100. Those of skill in the art will appreciate that the tack weld 305 is not necessary for all implementations, but may prove useful in certain circumstances depending upon the demands of the implementation.

While the various embodiments of this invention have been described in detail with particular reference to exemplary embodiments, those skilled in the art will understand that variations and modifications may be effected within the scope of the invention as defined in the appended claims. Accordingly, the scope of the various embodiments of the present invention should not be limited to the above discussed embodiments, and should only be defined by the following claims and all equivalents.

What is claimed is:

1. A non-circular duct segment, comprising:
a first joining element on a first non-circular duct segment; and
a first reinforcement region located proximate to the first joining element.

2. The non-circular duct segment of claim 1, wherein the a weld is located proximate the first joining element and a second joining element of a second non-circular duct segment.

3. The non-circular duct segment of claim 1, wherein a tack weld is located proximate the first joining element and a second joining element of a second non-circular duct segment.

4. The non-circular duct segment of claim 1, wherein the first reinforcement region comprises a welding bead.

5. The non-circular duct segment of claim 1, wherein the first reinforcement region comprises a bend in the first non-circular duct segment.

6. The non-circular duct segment of claim 1, wherein the first joining element is a standing seam.

7. The non-circular duct segment of claim 1, wherein the first non-circular duct segment comprises a first material and the first reinforcement region comprises an additional second layer of material.

8. The non-circular duct segment of claim 1, wherein the first reinforcement region is located no more than ⅓ of the total longitudinal length of the first non-circular duct segment from the first joining element.

9. The non-circular duct segment of claim 1, wherein the first reinforcement region is located no more than the length of the major axis of an opening in the first non-circular duct segment from the first joining element.

10. The non-circular duct segment of claim 1, wherein the first reinforcement region is located between 1 to 3 inches from the first joining element.

11. A method for providing a non-circular duct apparatus, comprising the steps of:
providing a first non-circular duct segment having a first joining element and a second non-circular duct segment having a second a joining element;
providing a first reinforcement region near the first joining element;
providing a second reinforcement region near the second joining element; and
mating the first joining element of the first non-circular duct segment with second joining element of the second non-circular duct segment.

12. The method for providing a duct system of claim 11, further comprising the step of welding together the first joining element of the first non-circular duct segment and the second joining element of the second non-circular duct segment.

13. The method for providing a duct system of claim 12, wherein the step of welding is performed with a tack weld.

14. The method for providing a duct system of claim 11, wherein the step of providing a first reinforcement region comprises forming a bend in the first non-circular duct segment near the first joining element and wherein the step of providing a second reinforcement region comprises forming a bend in the second non-circular duct segment near the second joining element.

15. The method for providing a duct system of claim 11, wherein the first reinforcement region and the second reinforcement region enable the non-circular duct apparatus to be more durable.

16. A non-circular duct apparatus, comprising:
a first non-circular duct segment having a first joining element and a first reinforcement region located proximate to the first joining element;
a second non-circular duct segment having a second joining element and a reinforcement region located proximate to the second joining element; and
wherein the a first joining element is mated to the second joining element.

17. The non-circular duct apparatus of claim 16, wherein the first joining element is welded to the second joining element.

18. The non-circular duct apparatus of claim 16, wherein the first joining element is tack welded to the second joining element.

19. The non-circular duct apparatus of claim 16, wherein the first reinforcement region is located no more than ⅓ of the total longitudinal length of the first non-circular duct segment from the first joining element and the second reinforcement region is located no more than ⅓ of the total longitudinal length of the second non-circular duct segment from the second joining element.

20. The non-circular duct apparatus of claim 16, wherein the first reinforcement region is located no more than the length of the major axis of an opening in the first non-circular duct segment from the first joining element and the second reinforcement region is located no more than the length of the major axis of an opening in the second non-circular duct segment from the second joining element.
